(19) United States
(12) Patent Application Publication
(10) Pub. No.: US 2013/0334947 A1
(43) Pub. Date: Dec. 19, 2013

(54) PRINTER ASSEMBLY STRUCTURE

(71) Applicant: HON HAI PRECISION INDUSTRY CO., LTD., New Taipei (TW)

(72) Inventor: TUI-CHIEN WU, New Taipei (TW)

(73) Assignee: HON HAI PRECISION INDUSTRY CO., LTD., New Taipei (TW)

(21) Appl. No.: 13/859,880

(22) Filed: Apr. 10, 2013

(30) Foreign Application Priority Data
Jun. 18, 2012 (TW) 101121814

(51) Int. Cl. B41J 29/13

(52) U.S. Cl. CPC B41J 29/13
USPC 312/326

(57) ABSTRACT

A printer assembly structure includes a base and a cover. The base includes a guiding member and a positioning member. The guiding member includes a slope. The positioning member defines a pivot hole and a cutout. The cutout interconnects the pivot hole with an outside of the positioning member. The cover includes a sliding member and a rotating member. The sliding member includes a rotating wheel which includes a shaft. The cover moves on the base between a closed position and an open position. In the closed position, the cover covers on the base with the rotating wheel located on the slope and the shaft protruded out of the pivot hole. In the open position, the rotating wheel slides to another end of the slope to engage with the shaft in the pivot hole via the cutout, and the shaft rotates in the pivot hole to rotate the cover.

### BACKGROUND

1. Technical Field

The present disclosure relates to an assembly structure, and more particularly to an assembly structure for printers.

2. Description of Related Art

As the development of electronic devices, printers are developed to be equipped with a scanner component to conveniently copy or scan printed materials. The scanner component is often covered by a cover, which is pivotally mounted on a main body of the printer. When scanning or copying the printed materials, the cover needs to be lifted to place the printed materials on the scanner. However, the cover may be heavy, and may be difficult to lift the cover.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of an embodiment of a printer assembly structure.

FIG. 2 is an enlarged view of an encircled portion II of FIG. 1.

FIG. 3 is an assembled view of the assembly structure of FIG. 1.

FIG. 4 is another assembled view of the assembly structure of FIG. 1.

FIG. 5 is an enlarged view of an encircled portion V of FIG. 4.

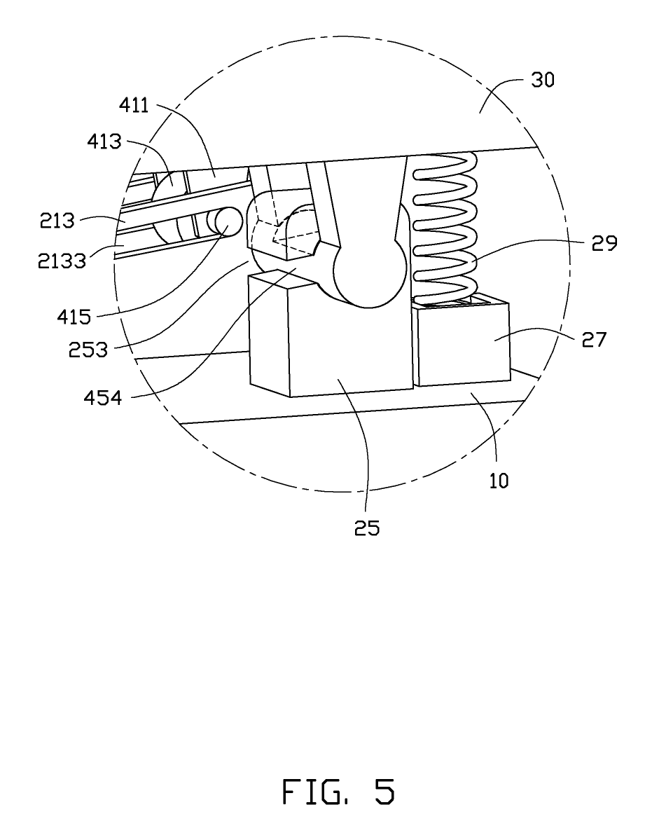

FIG. 6 is another assembled view of the assembly structure of FIG. 1.

FIG. 7 is an enlarged view of an encircled portion VII of FIG. 6.

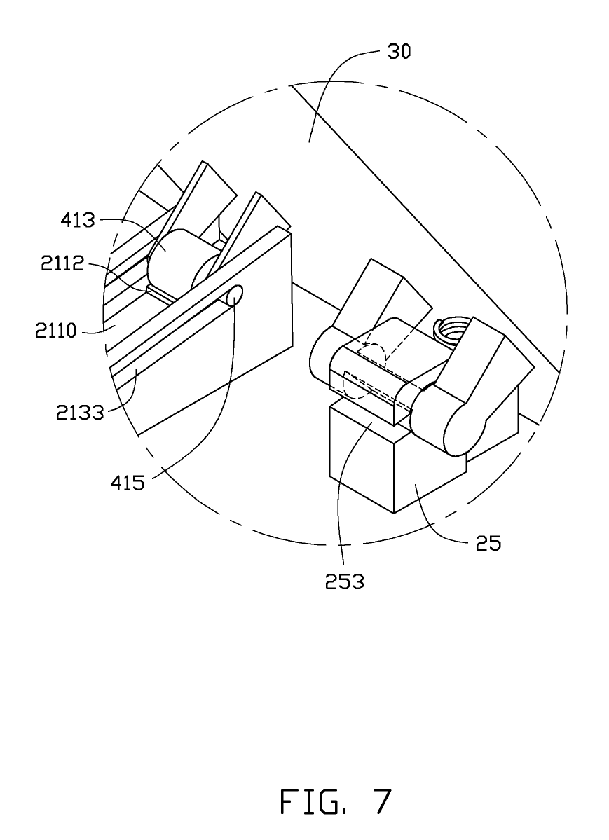

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

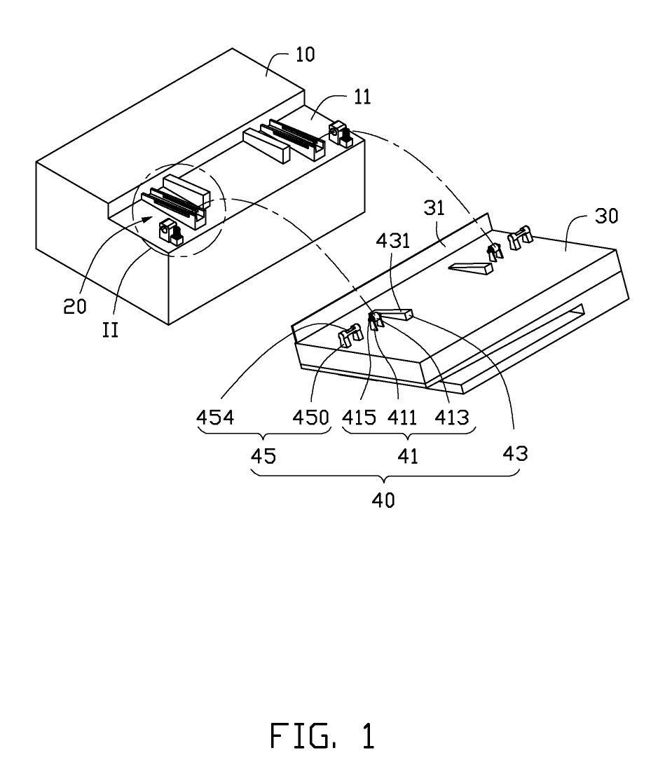

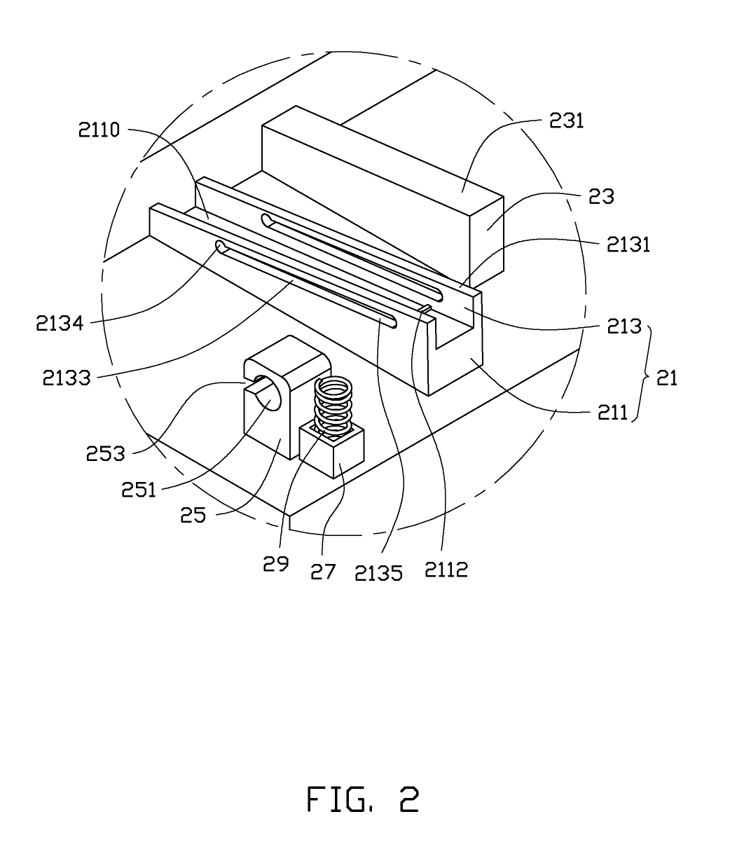

FIGS. 1 and 2 shows a printer assembly structure in accordance with an embodiment. The printer includes a base 10 and a cover 30. Two first matching combinations 20 are installed on the base 10. Two second matching combinations 40 are installed on the cover 30.

A top portion of the base 10 defines a recess 11. The two first matching combinations 20 are located in the recess 11. Each first matching combination 20 includes a guiding member 21, a first engaging block 23, a positioning member 25, and a receiving case 27. The guiding member 21 is located between the first engaging block 23 and the positioning member 25. The receiving case 27 is aligned with the positioning member 25.

The guiding member 21 includes a bottom portion 211 and a pair of side plates 213 perpendicularly connected to opposite edges of the bottom portion 211. The bottom portion 211 is connected to base 10. A slope 2110 is formed on the bottom portion 211. The slope 2110 is located between the pair of side plates 213. Each of the pair of side plates 213 defines a sliding groove 2133. Each sliding groove 2133 includes a first end 2134 and a second end 2135. The first end 2134 is located adjacent a central portion of the base 10, and the second end 2135 is located adjacent an edge portion of the base 10. A block 2112 is formed on the slope 2110. The first engaging block 23 includes an inclined first engaging surface 231. An inclined angle of the first engaging surface 231 is same as that of the slope 2110. The positioning member 25 defines a pivot hole 251 and a cutout 253. The cutout 253 enables the pivot hole 251 to communicate with an exterior of the positioning member 25. A spring 29 is vertically placed in the receiving case 27. One end of the spring 29 is secured in the receiving case 27.

An edge of the cover 30 forms a shielding plate 31. Each second matching combination 40 includes a second engaging block 43, a sliding member 41, and a rotating member 45. The second engaging block 43 defines an inclined second engaging surface 431 corresponding to the first engaging surface 231. The sliding member 41 includes a pair of supporting poles 411 and a rotating wheel 413. The pair of supporting poles 411 is connected to the cover 30. The rotating wheel 413 includes a pivot pin 415. The pivot pin 415 is pivotally mounted on the pair of supporting poles 411. Opposite ends of the pivot pin 415 extend out of the pair of supporting poles 411. The rotating member 45 includes a pair of supporting rods 450 and a shaft 454. The pair of supporting rods 450 is connected to the cover 30. The shaft 454 is connected between the pair of supporting rods 450.

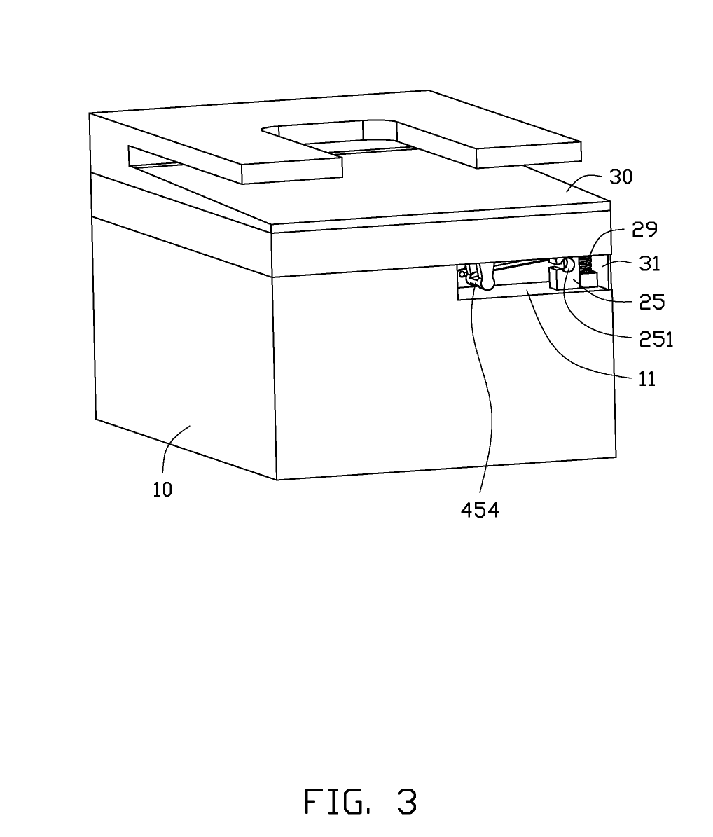

FIG. 3 shows that in assembly, the cover 30 covers the base 10. The second engaging surface 431 of the second engaging block 43 is placed on the first engaging surface 231 of the first engaging block 23. The rotating wheel 413 is located on the slope 2110 with the opposite ends of the pivot pin 415 inserted in the sliding groove 2133 of the pair of side plates 213. In this position, a free end of the spring 29 supports the cover 30.

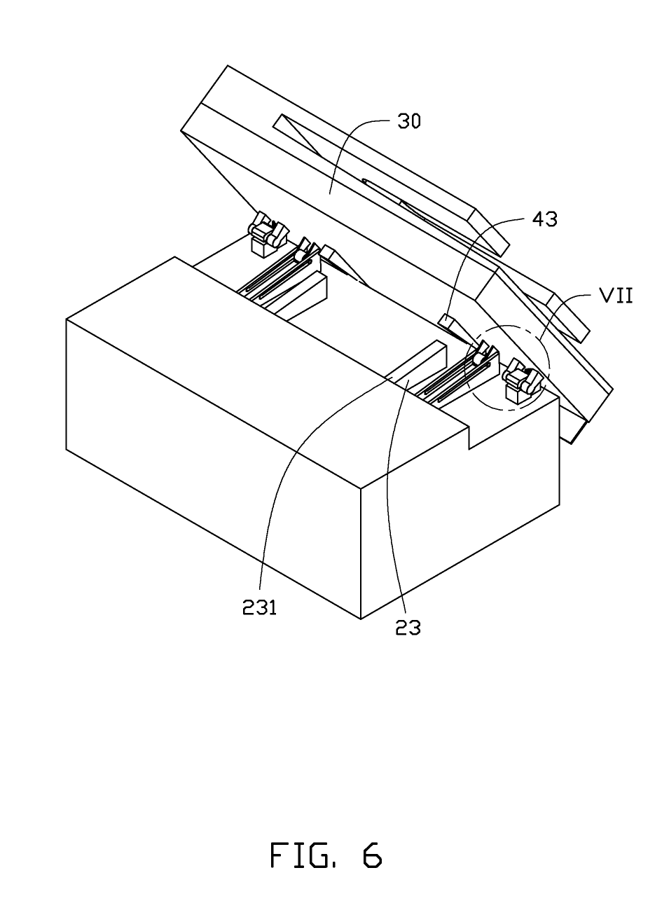

The cover 30 is adapted to move on the base 10 between a closed position (referring to FIG. 3) and an open position (referring to FIG. 6).

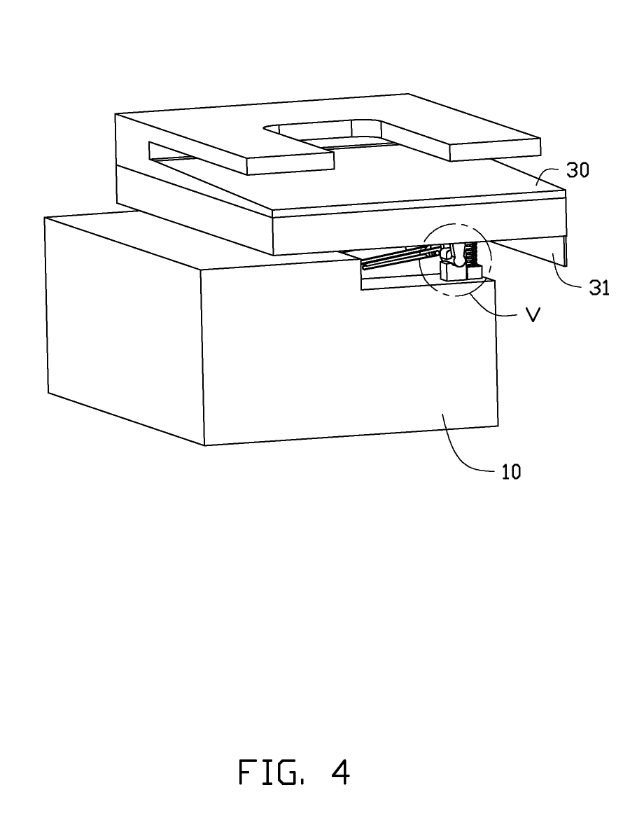

In the closed position, the sliding beams 415 are located on the first ends 2134 of the sliding grooves 2133, and the second engaging surface 431 is placed on the first engaging surface 231. When the cover 30 needs to be opened, the rotating wheel 413 rotates on the slope 2110 to move the slide the sliding beam 415 from the first end 2134 to the second end 2135 of the sliding groove 2133. Simultaneously, the second engaging surface 431 slides on the first engaging surface 231. When the rotating wheel 413 is blocked by the block 2112 on the slope 2110, the shaft 454 moves in the pivot hole 251 via the cutout 253 (referring to FIG. 4). It is easy to rotate the shaft 454 in the pivot hole 251 to remove the cover 30 from the base by the gravity of the cover 30. Therefore, the cover 30 is at the open position (referring to FIG. 6).

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A printer assembly structure, comprising:
a base comprising a guiding member and a positioning member, the guiding member comprising a slope, the positioning member defining a pivot hole and a cutout, and the pivot hole being interconnected with the cutout to an outside of the positioning member; and
a cover comprising a sliding member and a rotating member, the sliding member comprising a rotating wheel, the rotating member comprising a shaft;
wherein the cover is configured to move on the base between a closed position and an open position; in the closed position, the cover covers on the base with the rotating wheel located on the slope and the shaft protruding out of the pivot hole; and in the open position, the rotating wheel slides from one end of the slope to another end of the slope to engage with the shaft in the pivot hole via the cutout, and the shaft rotates in the pivot hole to rotate the cover.

2. The assembly structure of claim 1, wherein the guiding member comprises a bottom portion, and the slope is formed on the bottom portion.

3. The assembly structure of claim 2, wherein the guiding member comprises a pair of side plates each connected to each opposite edge of the bottom portion, each of the pair of side plates defines a sliding groove, the rotating wheel comprises a pivot pin, and opposites ends of the pivot pin are configured to slide in the sliding groove when the rotating wheel slides on the slope.

4. The assembly structure of claim 3, wherein each of the pair of sliding grooves comprises a first end and a second end, the first end is located adjacent a central portion of the base, the second end is located adjacent an edge portion of the base, and each end of the pivot pin is configured to be accommodated in the first end in the closed position, and in the second end in the open position.

5. The assembly structure of claim 1, wherein a block is formed on the slope, and the block is configured to resist the rotating wheel in the open position.

6. The assembly structure of claim 1, wherein the base comprises a first engaging block, the first engaging block defines a first engaging surface; the cover comprises a second engaging block, the second engaging block defines a second engaging surface, and the second engaging surface is configured to slide on the first engaging surface.

7. The assembly structure of claim 1, wherein the base comprises a receiving case, a spring is mounted in the receiving case, and the spring is configured to support the cover.

8. An assembly structure for a printer, comprising:
a base comprising a guiding member and a positioning member, the guiding member defining a sliding groove, the sliding grooves comprising a first end and a second end, the first end being adjacent a central portion of the base, the second end being adjacent an edge portion of the base; the positioning member defining a pivot hole and a cutout, and the pivot hole being interconnected with the cutout to an outside of the positioning member; and
a cover comprising a sliding member and a rotating member, the sliding member comprising a pivot pin, the pivot pin being inserted into the sliding groove, the rotating member comprising a shaft;
wherein the cover is configured to move on the base between a closed position and an open position; in the closed position, the cover covers on the base with the pivot pin in the first end of the sliding groove; and in the open position, the pivot pin slides from the first end to the second end of the sliding groove to engage with the shaft in the pivot hole via the cutout, and the shaft rotates in the pivot hole to rotate the cover.

9. The assembly structure of claim 8, wherein the guiding member comprises a bottom portion and a side plate connected to the bottom portion, the sliding groove is defined in the side plate, the bottom portion comprises a slope, a rotating wheel is pivotally mounted on the pivot pin, and the rotating wheel is configured to slide on the slope.

10. The assembly structure of claim 9, wherein a block is formed on the slope, and the block is configured to resist the rotating wheel in the open position.

11. The assembly structure of claim 8, wherein the base comprises a first engaging block, the first engaging block defines a first engaging surface; the cover comprises a second engaging block, the second engaging block defines a second engaging surface, and the second engaging surface is configured to slide on the first engaging surface.

12. The assembly structure of claim 8, wherein the base comprises a receiving case, a spring is mounted in the receiving case, and the spring is configured to support the cover.
